(19) United States
(12) Patent Application Publication
(10) Pub. No.: US 2012/0197601 A1
(43) Pub. Date: Aug. 2, 2012

(54) INFORMATION PROCESSING APPARATUS AND METHOD THEREFOR

(75) Inventors: Ken Matsui, Tokyo (JP); Takayuki Matsuura, Yokohama-shi (JP)

(73) Assignee: CANON KABUSHIKI KAISHA, Tokyo (JP)

(21) Appl. No.: 13/352,950

(22) Filed: Jan. 18, 2012

(30) Foreign Application Priority Data
Jan. 28, 2011 (JP) 2011-017117
Dec. 28, 2011 (JP) 2011-289898

(51) Int. Cl. G06F 17/50

(52) U.S. Cl. 703/1

(57) ABSTRACT

Two dimensional developed view data of a three dimensional structure is obtained. Layer structure information of a sheet-shaped component which has a laminated structure, and bend information of a indicated by the obtained data are input. For coordinates of the obtained data, a principal axis direction in which the shape of an inner structure of the component does not change is set. The layer structure information and information representing the principal axis direction are added to each surface indicated by the obtained data. The three dimensional shape of the three dimensional structure is generated using the obtained data and the bend information. Using the layer structure information and the information representing the principal axis direction added to each surface, a three dimensional model in which the shape of the laminated structure of the component is added to each surface indicated by the three dimensional shape is generated.

### BACKGROUND OF THE INVENTION

1. Field of the Invention

The present invention relates to information processing of generating the three dimensional shape of a three dimensional structure based on the two dimensional developed view data of the three dimensional structure.

2. Description of the Related Art

Computer aided design (CAD) is widely used to design components and products. As one operation in CAD, a three dimensional CAD model is generated based on a two dimensional CAD model to perform analysis using a finite element method.

As a method of modeling a structure, Japanese Patent Laid-Open No. 2005-115555 (literature 1) discloses a technique for interactively generating, based on an existing two dimensional CAD model, the three dimensional model of a sheet metal product, which can be automatically developed. That is, the sheet metal product is recognized as a planar portion and a bending part based on the two dimensional CAD information of two directions such as a front view and a side view, and whether it is possible to generate a sectional shape is verified. If it is possible to generate a sectional shape, the three dimensional CAD model of the sheet metal product, which has an extruded sectional shape, is generated based on the planar portion, bending part, and length information of the sheet metal product.

As another method of modeling a structure, Japanese Patent Laid-Open No. 7-141527 (literature 2) discloses a technique of generating the three dimensional CAD model of a sheet metal product based on the two dimensional CAD model of the sheet metal product. That is, information about the radius of curvature and bending angle of each bend line in a two dimensional developed view is referred to, and rotational sweep is performed with respect to a cross section in a sheet thickness direction, thereby generating a bend model. Furthermore, for two planar portions as a region except for the bend lines, a translational sweep is performed by a distance corresponding to the sheet thickness, thereby generating a planar portion model. After that, the planar portion model and bend model are combined, thereby generating the three dimensional model of the sheet metal product.

There exists a sheet material (to be referred to as a laminated sheet or laminate hereinafter) having a laminated structure like a corrugated cardboard. If, for example, drop analysis is performed for a structure formed by a laminated sheet, a model which also represents an inner laminated structure as a shape is needed to keep the analysis accuracy. With respect to structure modeling, both the techniques disclosed in literatures 1 and 2 are only applicable to a structure which does not have a laminated structure like a sheet metal and can be represented by a shape that is uniform in the sheet thickness direction. In many cases, this is because a procedure of bending each surface in the two dimensional developed view by considering it as a mid surface serving as a reference surface, equally giving a thickness as an attribute to all the surfaces, and generating a three dimensional outer shape is used. Note that the mid surface indicates the central surface of the sheet thickness of a member.

When attempting an analysis by reproducing the internal structure of the laminated sheet using the conventional techniques, a three dimensional CAD model must be manually generated before performing the analysis as an original purpose. Furthermore, only two dimensional developed view data is often given as the design drawing of a structure formed by a laminated sheet, and therefore, it is necessary to manually generate a three dimensional shape based on the two dimensional view. As described above, to analyze a structure formed by a laminated sheet, a large number of steps are required to generate a three dimensional CAD model and problems are met in decreasing the number of steps.

### SUMMARY OF THE INVENTION

In one aspect, an information processing apparatus comprises: an obtaining section, configured to obtain two dimensional developed view data of a three dimensional structure; an inputting section, configured to input layer structure information of a sheet-shaped component which has a laminated structure and includes an inner structure having a corrugated form, and bend information of a bend indicated by the two dimensional developed view data; a setting section, configured to set, for coordinates of the two dimensional developed view data, a principal axis direction indicating a direction in which a shape of the inner structure does not change; an adding section, configured to add the layer structure information and information representing the principal axis direction to each surface indicated by the two dimensional developed view data; a first generator, configured to generate a three dimensional shape of the three dimensional structure using the two dimensional developed view data and the bend information; and a second generator, configured to generate, using the layer structure information and the information representing the principal axis direction which have been added to each surface, a three dimensional model in which a shape of the laminated structure of the sheet-shaped component is added to each surface indicated by the three dimensional shape.

According to the aspect, it is possible to efficiently generate the three dimensional shape of a structure formed by a sheet-shaped component having a laminated structure.

Further features of the present invention will become apparent from the following description of exemplary embodiments with reference to the attached drawings.

### BRIEF DESCRIPTION OF THE DRAWINGS

FIG. 1 is a block diagram for explaining the arrangement of an information processing apparatus.

FIG. 2 is a flowchart for explaining processing of generating a three dimensional CAD model and an analytic model based on two dimensional developed view data.

FIGS. 3A and 3B are views showing an example of the structure of the two dimensional developed view data.

FIG. 4 is a view for explaining an example of the structure of a corrugated cardboard.

FIG. 5 is a view showing an example of a UI for inputting layer structure information.

FIG. 6 is a view showing an example of a UI for inputting bend information.

FIG. 7 is a view showing an example of a three dimensional shape generated based on the two dimensional developed view data.

FIG. 8 is a view showing a status example in which an inner laminated structure is added to the three dimensional shape generated based on the two dimensional developed view data.

FIG. 9 is a view showing an example of a UI for inputting the principal axis direction of the inner laminated structure and the definition of the surfaces of a laminated sheet.

FIG. 10 is a view showing an example of a three dimensional shape creation result.

FIG. 11 is a view showing a case in which three dimensional shape data is generated based on the two dimensional developed view data.

FIGS. 12A and 12B are views showing an example of the data structure of the three dimensional shape data.

FIGS. 13A and 13B are views for explaining an example of processing of defining and generating the shape information of the inner laminated structure as the shape of the three dimensional CAD model.

FIG. 14 is a view for explaining a case in which the sectional shape of the inner laminated structure of the corrugated cardboard is generated.

FIG. 15 is a view showing an example of a UI for inputting physical property values, boundary conditions, and the like.

FIG. 16 is a block diagram for explaining the arrangement of an information processing apparatus according to the second embodiment.

FIG. 17 is a flowchart for explaining processing of generating a three dimensional CAD model and an analytic model based on two dimensional developed view data.

FIG. 18 is a view showing an example of a UI for inputting sheet thickness change information.

FIG. 19 is a flowchart for explaining details of processing of creating a three dimensional shape with a corrected developed length.

FIG. 20 is a view showing an example of a three dimensional shape creation result with a corrected developed length.

FIG. 21 is a view showing another example of the three dimensional shape creation result with a corrected developed length.

FIGS. 22A to 22C are views each showing an example of a three dimensional outer shape created based on two dimensional developed view data.

FIGS. 23A and 23B are views each showing an example of a three dimensional shape created based on the two dimensional developed view.

FIG. 24 is a view showing a case in which three dimensional shape data is created based on two dimensional developed view data.

FIGS. 25A and 25B are views showing an example of the data structure of the three dimensional shape data.

### DESCRIPTION OF THE EMBODIMENTS

Information processing according to an embodiment of the present invention will be described in detail with reference to the accompanying drawings. Note that a case in which the present invention is applied to creation of the three dimensional shape of a structure formed by a corrugated cardboard and creation of an analytic model will be explained. Note also that in addition to a corrugated cardboard, a material applicable with the present invention includes a sheet composite material having orthotropy such as a fiber-reinforced plastic sheet. An analytic model to be described below indicates that obtained by reproducing a sheet-shaped component (to be referred to as a laminated sheet or laminate) having a laminated structure and the whole structure formed by the laminated sheet.

### First Embodiment

### [Arrangement of Apparatus]

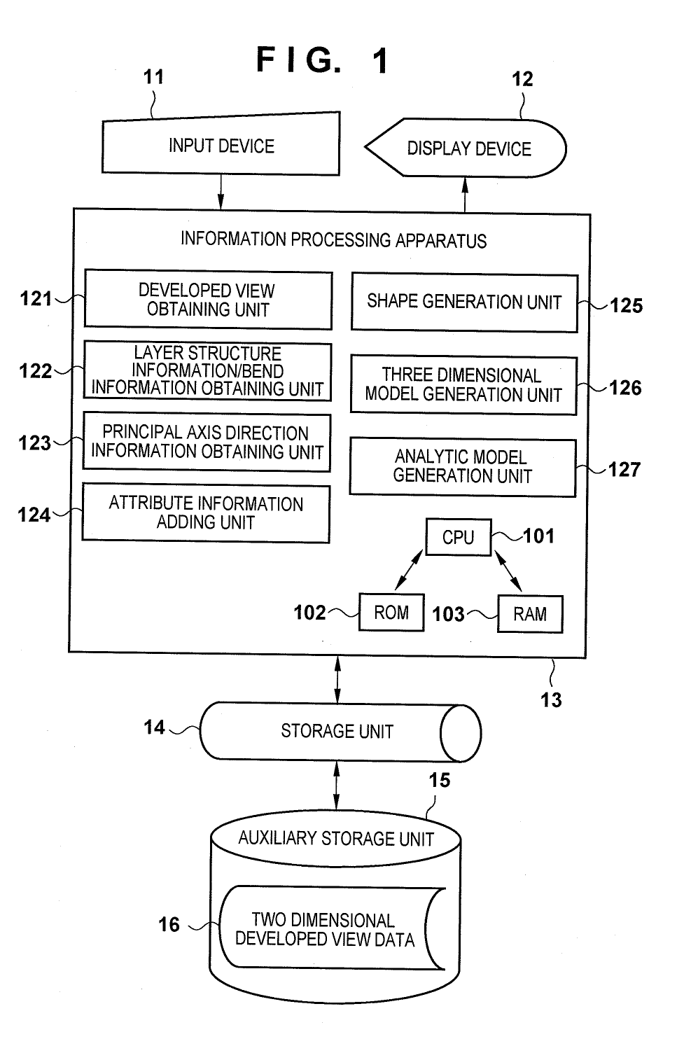

The arrangement of an information processing apparatus 13 for generating the shape of a structure formed by a laminated sheet will be described with reference to a block diagram shown in FIG. 1. That is, FIG. 1 shows a computer system for executing three dimensional CAD model creation processing and three dimensional analytic model creation processing. Note that the computer system shown in FIG. 1 can be implemented by installing CAD system software having functions of the present invention in a computer such as a personal computer, and executing it.

The information processing apparatus 13 includes, in itself, a microprocessor (CPU) 101, a read-only memory (ROM) 102, and a random access memory (RAM) 103. The information processing apparatus 13 is connected with an input device 11 such as a keyboard and mouse, a display device 12 serving as a monitor such as a liquid crystal display (LCD), and a storage unit 14 such as a hard disk drive (HDD) and semiconductor memory. Furthermore, the apparatus 13 is connected with an auxiliary storage unit 15 such as a removable disk drive used to store or exchange data, and the like. Note that data can be exchanged via a server apparatus on a network instead of the auxiliary storage unit 15.

The CPU 101 implements functional blocks 121 to 127 shown in FIG. 1 by loading an operating system (OS) and the CAD system software stored in the ROM 102 or storage unit 14 into the RAM 103, and executing them.

The developed view obtaining unit 121 obtains data indicating a shape and dimensions from the two dimensional developed view data of a three dimensional structure formed by a laminated sheet, for which a three dimensional CAD model and three dimensional analytic model are generated.

The layer structure information/bend information obtaining unit 122 obtains structure information indicating the shape and dimensions of the laminated sheet as an inner laminated structure and the bend information of the laminated sheet.

The principal axis direction information obtaining unit 123 obtains information (to be referred to as principal axis direction information hereinafter) indicating the principal axis direction of the laminated sheet. The principal axis direction information obtaining unit 123 may automatically obtain the principal axis direction information of an arbitrary surface (reference surface), or may obtain the principal axis direction information of a surface (reference surface) designated by a user. Note that “principal axis direction” will be described in detail later.

The attribute information adding unit 124 defines, for all surfaces, the layer structure information and bend information of the laminated sheet and the main principal axis direction information of the laminated sheet.

Based on the shape and dimensions of the three dimensional structure, and the structure information, bend information, and principal axis direction information of the laminated sheet, the shape generation unit 125 generates the three dimensional shape of the structure as a whole when the laminated sheet is bent by considering a mid surface as a reference surface.

For the three dimensional sheet shape generated by the shape generation unit 125, the three dimensional model generation unit 126 generates a three dimensional CAD model as a detailed three dimensional shape having a continuous and periodic inner laminated structure across neighboring surfaces.

The analytic model generation unit 127 generates an analytic model based on the three dimensional CAD model defined by the three dimensional model generation unit 126. Generating the analytic model includes a general analysis operation such as creation of a mesh model, definition of a material, and setting of boundary conditions.

### [Creation Processing of Three Dimensional CAD Model and Analytic Model]

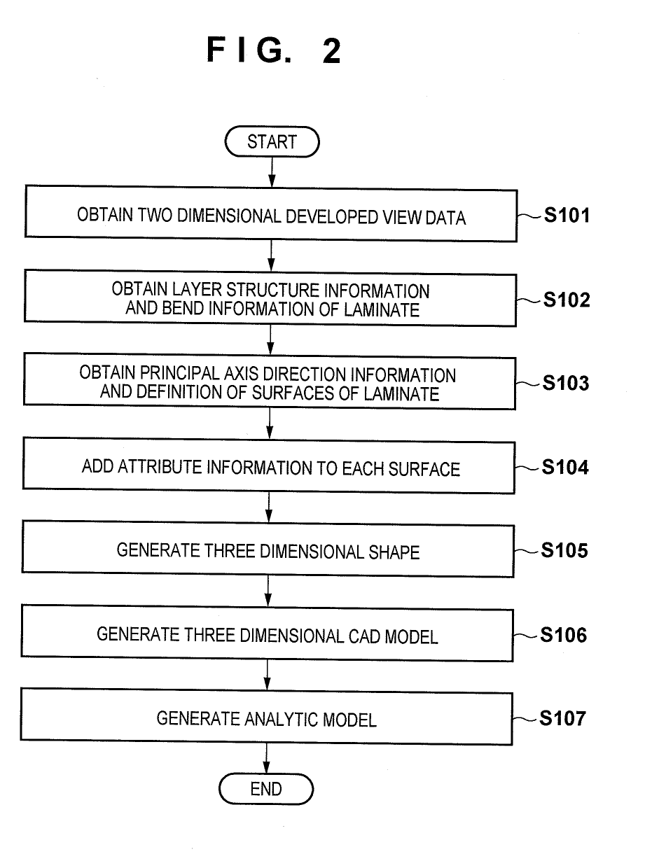

Processing of generating a three dimensional CAD model and an analytic model based on two dimensional developed view data will be described with reference to a flowchart shown in FIG. 2.

### Obtaining of Two Dimensional Developed View Data (S101)

The developed view obtaining unit 121 obtains two dimensional developed view data 16 which is stored in the auxiliary storage unit 15 and is designated by the user (S101).

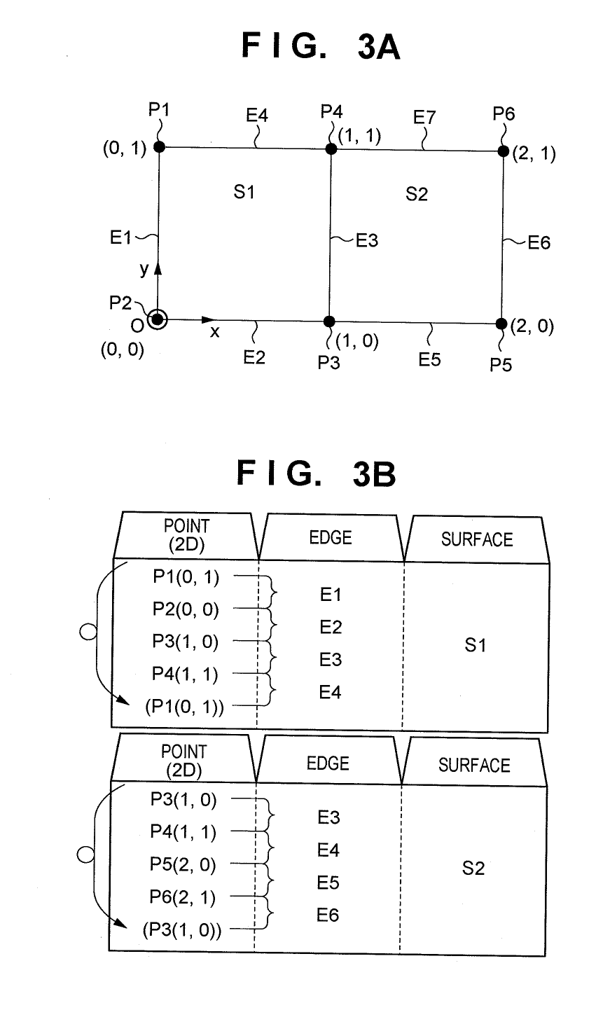

FIGS. 3A and 3B show an example of the structure of the two dimensional developed view data. As shown in FIG. 3A, the two dimensional developed view data contains four point data P each of which indicates a vertex of a surface and has a two dimensional coordinate value, four edge data E defined by two pieces of point information, and one surface data S defined by the four edge data. FIG. 3B shows an example of the data structure of the two dimensional developed view data. That is, the two dimensional developed view data has a hierarchical structure which includes data of edges E forming each surface S, and data of points P forming each edge E. Note that FIGS. 3A and 3B only show information for two surfaces but information for the number of surfaces in a developed view actually exists.

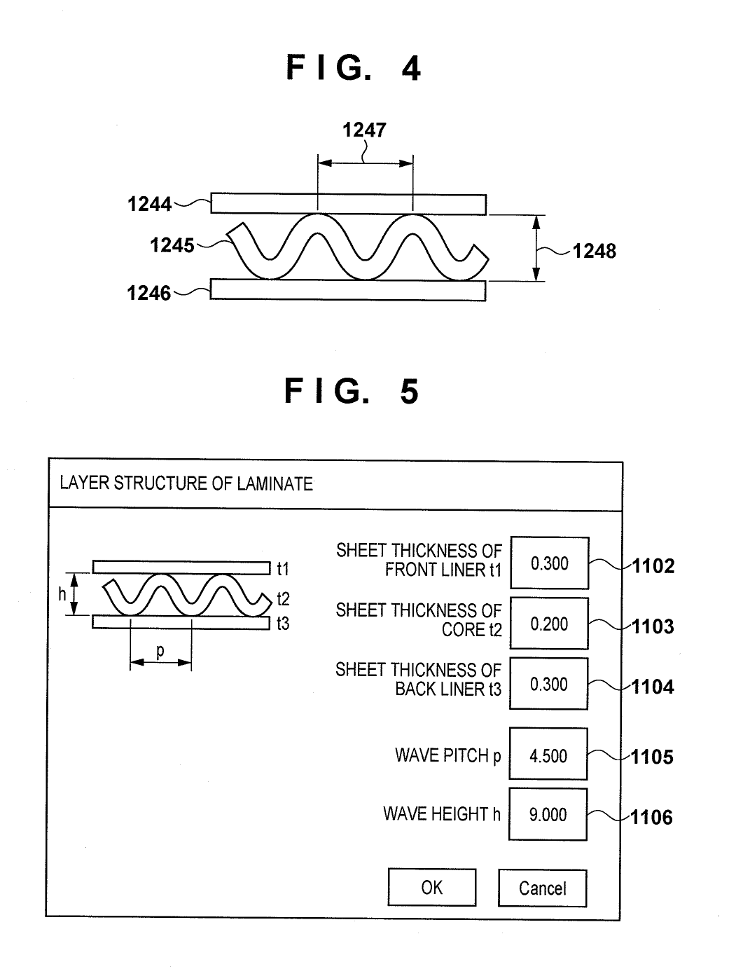

An example of the structure of a corrugated cardboard will be explained with reference to FIG. 4. A corrugated cardboard is handled as a sheet-shaped component, and its cross section is formed by three paper sheets or plastic sheets. A front liner 1244 positioned on a front surface is one flat sheet. A core 1245 as an inner structure positioned in the middle is one sheet but has a regularly and continuously changing sinusoidal form (to be referred to as a corrugated form hereinafter) which can be represented by a wave pitch 1247 and a wave height 1248. A back liner 1246 positioned on a rear surface is one flat sheet like the front liner 1244. The thicknesses of the three sheets may be identical or different depending on a use.

Obtaining of Layer Structure Information and Bend information (S102)

The layer structure information/bend information obtaining unit 122 obtains the layer structure information and bend information of a laminated sheet using a user interface (UI) (S102). That is, the layer structure information/bend information obtaining unit 122 obtains various kinds of attribute information held by the corrugated cardboard shown in FIG. 4.

FIG. 5 shows an example of a UI for inputting the layer structure information. The layer structure information/bend information obtaining unit 122 displays the UI shown in FIG. 5 on the display device 12. The user inputs the layer structure information of a laminated sheet using the input device 11 and the UI shown in FIG. 5. That is, the user inputs a sheet thickness t1 of the front liner 1244 in an input column 1102, a sheet thickness t2 of the core 1245 in an input column 1103, a sheet thickness t3 of the back liner 1246 in an input column 1104, a wave pitch p in an input column 1105, and a wave height h in an input column 1106.

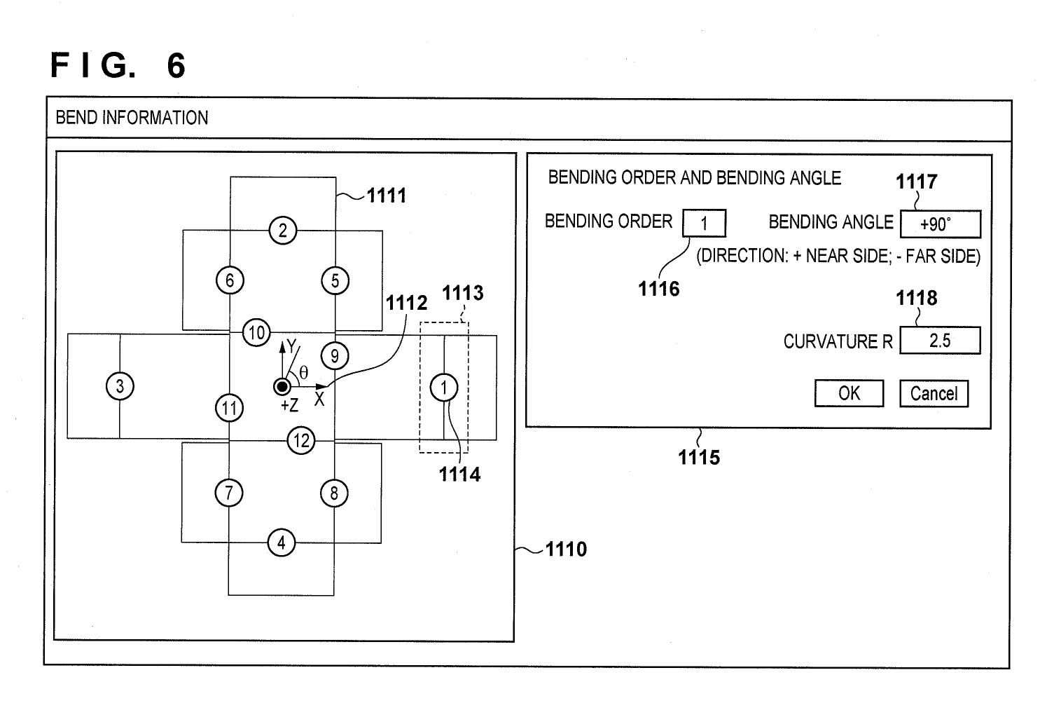

When the user inputs numerical values in the respective columns of the UI shown in FIG. 5, and presses an OK button, the layer structure information/bend information obtaining unit 122 displays, on the display device 12, a UI for obtaining bend information. FIG. 6 shows an example of the UI for inputting bend information.

The UI shown in FIG. 6 has a window 1110 for displaying the bend information of the laminated sheet in a two dimensional developed view, and a window 1115 for displaying settings of a selected bending part. As denoted by reference numeral 1112, a three dimensional coordinate system designated by the user is displayed within the window 1110. The user inputs the information of a bending part through the input device 11 using the windows 1110 and 1115.

When the user selects a ridgeline as a bending part in the window 1110, broken lines 1113 or the like indicating a selected region which surrounds the selected ridgeline are displayed, and a number indicating a bending order is displayed on the ridgeline as denoted by reference numeral 1114. In response to selection of a ridgeline, the bending order of the ridgeline is displayed in a display column 1116 of the window 1115. The user inputs the bending angle and radius of curvature (curvature R) of the selected ridgeline in input columns 1117 and 1118, respectively. Note that the user repeats selection of a bending part and input of a bending angle and a curvature R the number of times which is equal to that of bending parts.

When the user inputs the bending angle and curvature R of each ridgeline displayed on the UI shown in FIG. 6, and presses an OK button, the operation of obtaining the layer structure information and bend information by the layer structure information/bend information obtaining unit 122 ends.

Note that a method in which the user inputs layer structure information and bend information using the UIs has been described. If, however, two dimensional developed view data contains layer structure information and bend information, the layer structure information/bend information obtaining unit 122 can obtain the layer structure information and bend information from the two dimensional developed view data.

### Obtaining of Principal Axis Direction Information (S103)

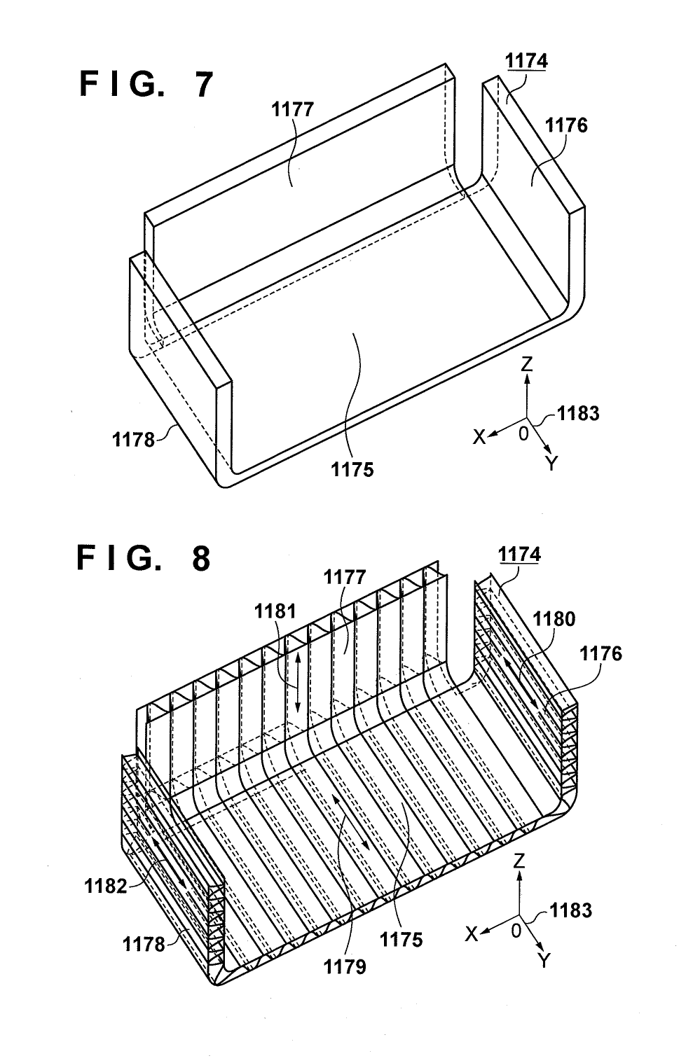

FIG. 7 shows an example of a three dimensional shape generated based on the two dimensional developed view data. When generating the three dimensional solid model of a sheet metal structure as a three dimensional shape, and then generating the three dimensional CAD model of a corrugated cardboard based on the three dimensional shape, an operation of adding the internal structure of the laminated sheet as an additional attribute is performed. FIG. 8 shows a status example in which an inner laminated structure is added to the three dimensional shape generated based on the two dimensional developed view data.

In the corrugation of the core 1245 of the corrugated cardboard, a direction in which the phase changes is, in a plane, perpendicular to a direction in which the phase does not change. Of the two directions orthogonal to each other, the direction in which the phase does not change serves as a “principal axis direction”. In other words, a direction in which the shape of an inner structure having the corrugated form does not change (a direction perpendicular to the corrugation) with respect to the coordinates of the two dimensional developed view data serves as a “principal axis direction”.

If an inner laminated structure is added to the three dimensional shape shown in FIG. 7, principal axis directions 1179 to 1182 are given to a bottom surface 1175, right side surface 1176, rear surface 1177, and left side surface 1178 of the structure, respectively, as shown in FIG. 8. Based on the principal axis direction designated in the two dimensional developed view data, a principal axis direction needs to be appropriately determined at each point with respect to a coordinate system 1183 as a reference in generating a structure.

The principal axis direction information obtaining unit 123 obtains the definition (a front surface or rear surface) of the surfaces of the laminated sheet and the principal axis direction of orientation of the inner laminated structure (S103). Note that in the definition of the surfaces, the user defines the relationship between a surface of the laminated sheet and each surface indicated by the two dimensional developed view data, that is, whether the surface indicated by the two dimensional developed view data corresponds to the front surface (front liner) or rear surface (back liner) of the laminated sheet.

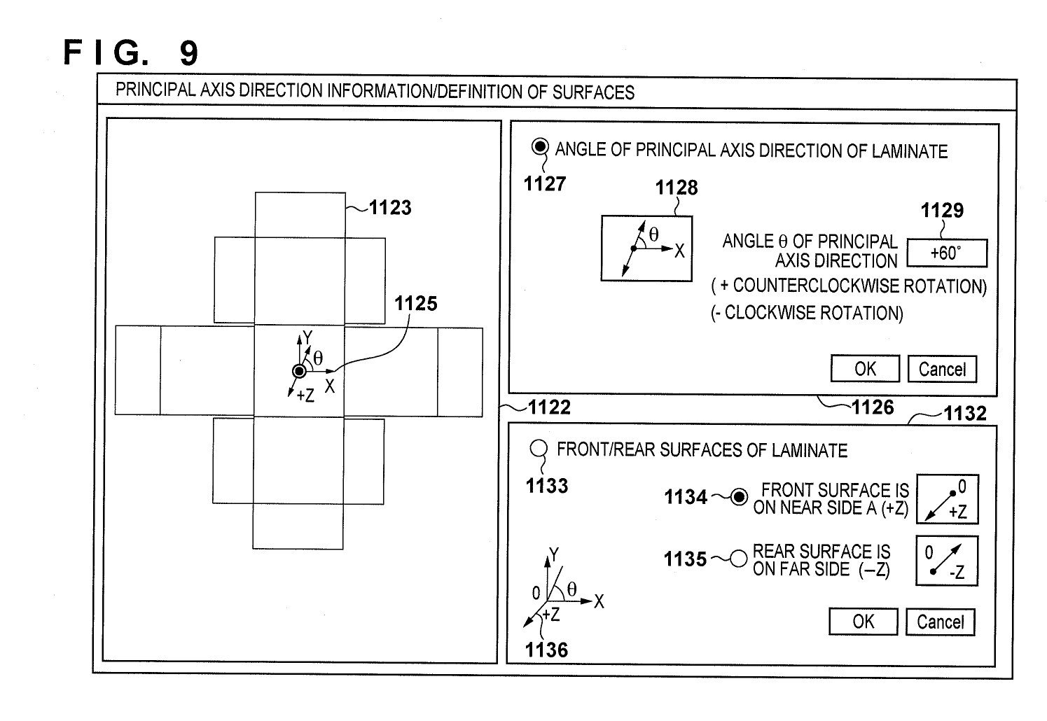

FIG. 9 shows an example of a UI for inputting the definition of the surfaces of the laminated sheet and the principal axis direction of the inner laminated structure. The principal axis direction information obtaining unit 123 displays the UI shown in FIG. 9 on the display device 12. The UI shown in FIG. 9 has a window 1122 for displaying a setting status of the principal axis direction of the laminated sheet in a two dimensional developed view, a window 1126 for defining the angle of the principal axis direction of the laminated sheet, and a window 1132 for defining the surfaces of the laminated sheet. As denoted by reference numerals 1125, 1128, and 1136, a three dimensional coordinate system designated by the user is displayed in each of the windows 1122, 1126, and 1132.

The user selects a radio button 1127 in the window 1126, and inputs an angle θ of the principal axis direction of the laminated sheet in an input column 1129. According to the value input by the user, the principal axis direction information obtaining unit 123 displays the angle θ of the principal axis direction in addition to the three dimensional coordinate system in each window, and displays a double-headed arrow for representing the angle θ formed with the X axis, the numerical value of the angle θ formed with the X axis, and the like.

The user selects a radio button 1133 in the window 1132, and selects a radio button 1134 or 1135 for defining the surfaces of the laminated sheet. Note that the definition of the surfaces of the laminated sheet is necessary when the thickness of the front liner 1244 of the laminated sheet is different from that of the back liner 1246 of the laminated sheet. When the user selects the radio button 1134, the near side (+Z side) of the two dimensional developed view displayed in the window 1122 is defined as a front surface (front liner). When the user selects the radio button 1135, the far side (−Z side) of the two dimensional developed view displayed in the window 1122 is defined as a front surface (front liner).

The order of input of the angle θ of the principal axis direction and definition of the surfaces of the laminated sheet is arbitrary. When the user completes definition of the angle θ of the principal axis direction and the surfaces of the laminated sheet which is displayed on the UI shown in FIG. 9, and presses an OK button, the operation of obtaining the definition of the angle θ of the principal axis direction and the surfaces of the laminated sheet by the principal axis direction information obtaining unit 123 ends.

A case in which the identical values are automatically set to all the surfaces contained in the two dimensional developed view has been described. The user, however, can select one surface in the window 1122, and define the angle θ of the principal axis direction of the selected surface and the surfaces of the laminated sheet. Note that in the case of a corrugated cardboard, selecting one arbitrary surface gives the same principal axis direction regardless of automatic or manual operation. In other words, the principal axis directions of the corrugated cardboard are identical on all the surfaces of the two dimensional developed view.

### Adding of Attribute Information (S104)

The attribute information adding unit 124 adds, as attribute information, layer structure information, bend information, principal axis direction information, and the definition of surfaces to all surfaces (S104).

### Creation of Three Dimensional Shape (S105)

Based on a shape and dimensions indicated by the two dimensional developed view data, and the bend information of the laminated sheet, the shape generation unit 125 generates a sheet-shaped three dimensional shape formed by planar portions and a bending part by considering a mid surface as a reference surface. Note that the reference surface is not limited to the mid surface, and may be an outer surface or inner surface. The shape generation unit 125 also adds a unit vector V representing the principal axis direction of the laminated sheet to the two dimensional developed view data, which will be described in detail later.

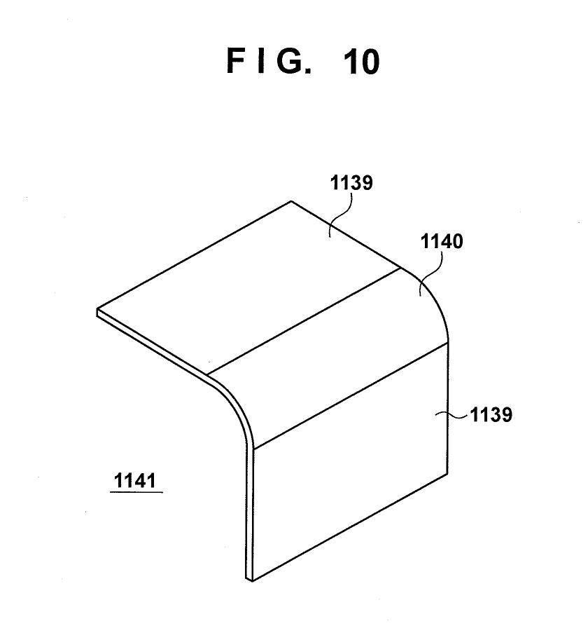

FIG. 10 shows an example of a three dimensional shape creation result. The three dimensional shape is represented as a mid surface three dimensional model 1141 formed by planar portions 1139 and a bending part 1140.

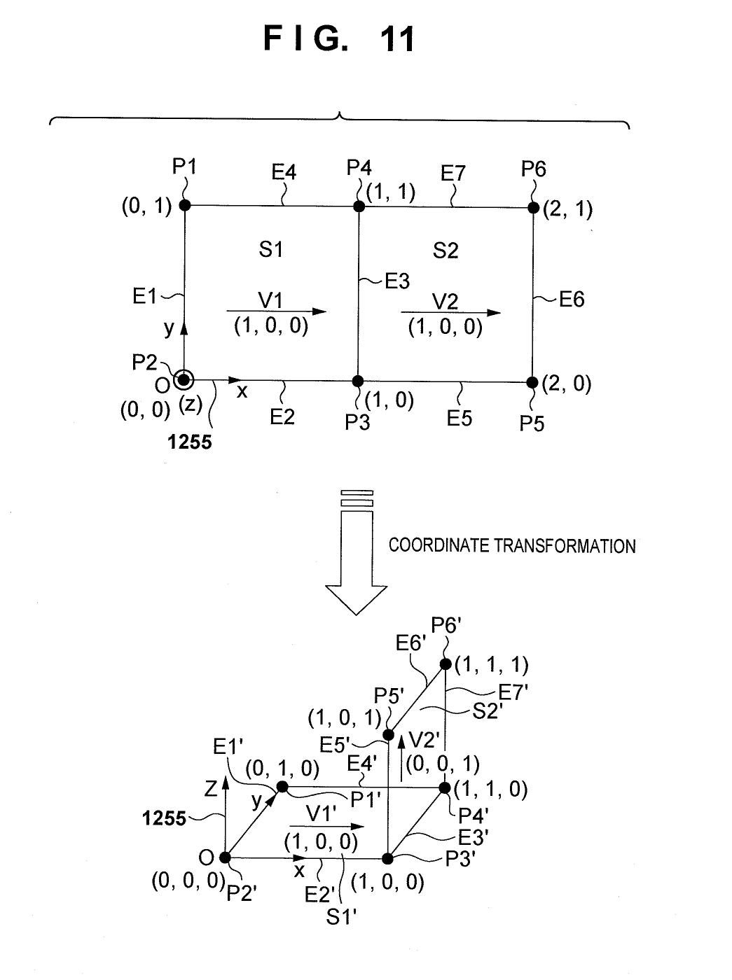

FIG. 11 shows a case in which three dimensional shape data is generated based on two dimensional developed view data. Note that the two dimensional developed view data shown in FIG. 11 shows two surfaces like FIG. 3A for descriptive convenience. An actual structure, however, has more surfaces, as a matter of course.

Based on the two dimensional information of the two dimensional developed view data, and the layer structure information, bend information, principal axis direction information, definition of surfaces and reference surface (for example, mid surface) of the laminated sheet, the shape generation unit 125 sets a three dimensional coordinate system 1255, and generates three dimensional information (a three dimensional shape) (S105).

To generate three dimensional information, a rotating coordinate transformation about a bending line (ridgeline) and the like need only be performed. For example, points P1 to P6 shown in FIG. 11 are coordinate-transformed to generate points P1′ to P6′, which coordinate-transforms edges E1 to E7 to edges E1′ to E7′, and surfaces S1 and S2 to surfaces S1′ and S2′. In the example shown in FIG. 11, especially the positions of the points P5 and P6 and the edges E5 to E7 move in the positive Z axis direction (+Z direction).

As shown in FIG. 11, the shape generation unit 125 adds, to the two dimensional developed view data, unit vectors V1 and V2 each representing the principal axis direction of the laminated sheet. Along with the coordinate transformation of points P in creation of three dimensional information, the unit vectors V1 and V2 are coordinate-transformed to unit vectors V1′ and V2′, respectively. In other words, it is possible to generate three dimensional information indicating the principal axis direction of each surface. According to a conventional method, it is necessary to set a principal axis direction for each surface after generating three dimensional information based on the two dimensional developed view data. According to the embodiment, the principal axis direction of each surface is generated when generating three dimensional information, which eliminates the need for setting a principal axis direction after generating the three dimensional information.

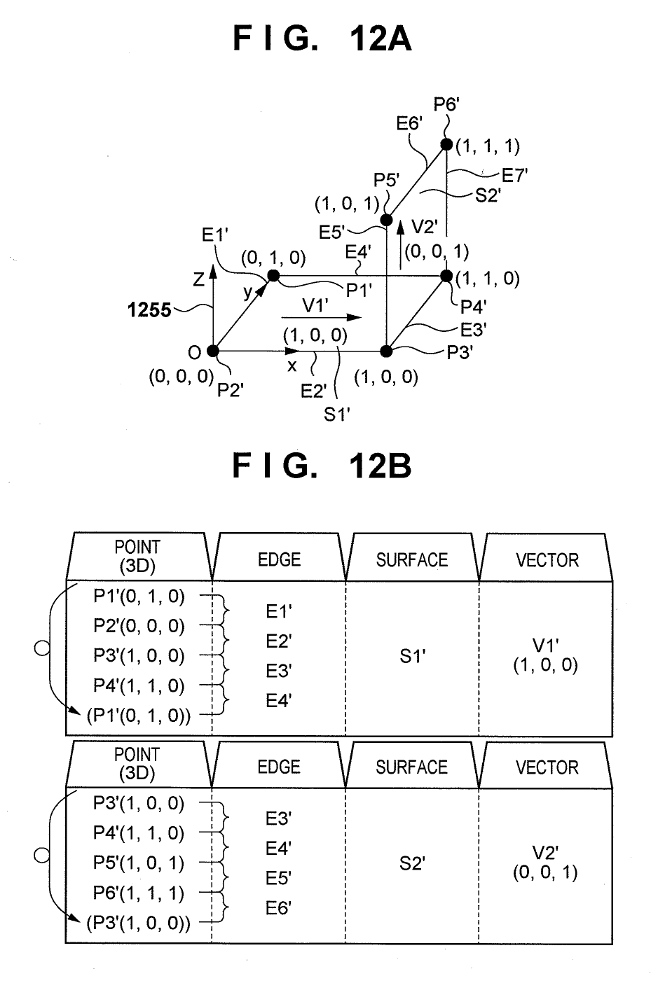

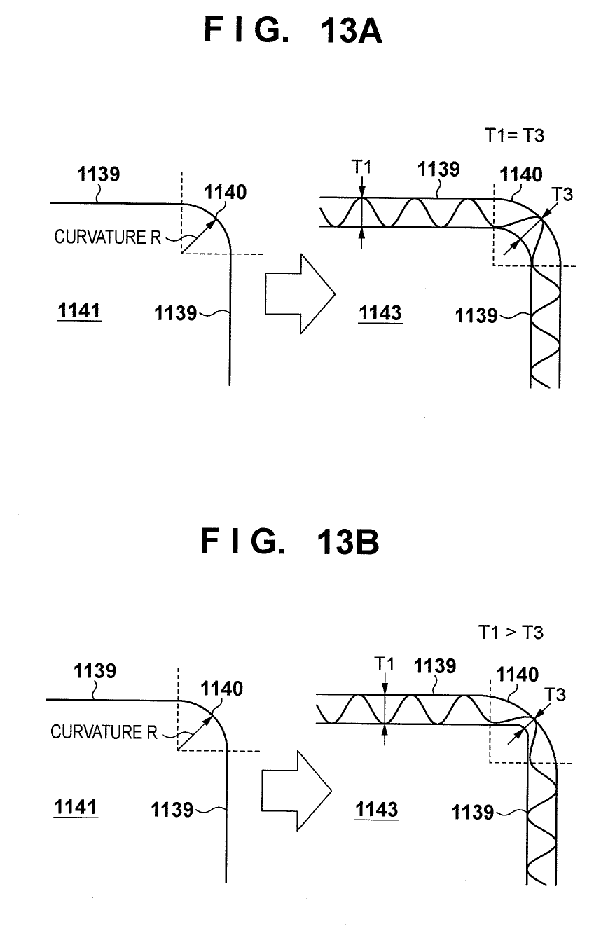

FIGS. 12A and 12B show an example of the data structure of the three dimensional shape data. The three dimensional shape data shown in FIG. 12A has a data structure example shown in FIG. 12B. That is, the three dimensional shape data has a hierarchical structure which includes data of edges E forming each surface S and data of points P forming each edge E, and data of vectors V each indicating a principal axis direction. Note that FIGS. 12A and 12B only show information for two surfaces but information for the number of surfaces in the developed view actually exists.

As described above, the three dimensional information generation procedure by the shape generation unit 125, that is, a procedure of generating three dimensional shape based on the two dimensional developed view data can use a conventional method such as coordinate transformation. By adding the unit vectors V each representing a principal axis direction to the two dimensional development view data, it is possible to generate unit vectors each representing the principal axis direction of each surface in the three dimensional shape.

### Creation of Three Dimensional CAD Model (S106)

Based on the three dimensional shape generated by the shape generation unit 125, the three dimensional model generation unit 126 defines and generates, as the shape of a three dimensional CAD model, the shape information of the continuous and periodic inner laminated structure over the two planar portions 1139 which sandwiches the bending part 1140 therebetween (S106). An example of processing of defining and generating the shape information of the inner laminated structure as the shape of a three dimensional CAD model will be described with reference to FIGS. 13A and 13B.

FIG. 13A shows a case in which a condition that a sheet thickness T1 of the planar portion 1139 is equal to a sheet thickness T2 of the bending part 1140 is set, the shape information of the continuous and periodic inner laminated structure is collectively defined, and a three dimensional CAD model 1143 is generated based on the three dimensional shape (mid surface three dimensional model) 1141. That is, FIG. 13A shows an example of a creation operation of the three dimensional CAD model 1143 under the creation condition that the sheet thickness does not change (T1=T2).

FIG. 13B shows a case in which a condition that a sheet thickness T3 of the bending part 1140 is thinner than the sheet thickness T1 of the planar portion 1139 is set, the shape information of the continuous and periodic inner laminated structure is collectively defined, and a three dimensional CAD model 1143 is generated based on the mid surface three dimensional model 1141. That is, FIG. 13B shows an example of a creation operation of the three dimensional CAD model 1143 under the creation condition that the sheet thickness decreases in the bending part 1140 (T1>T3).

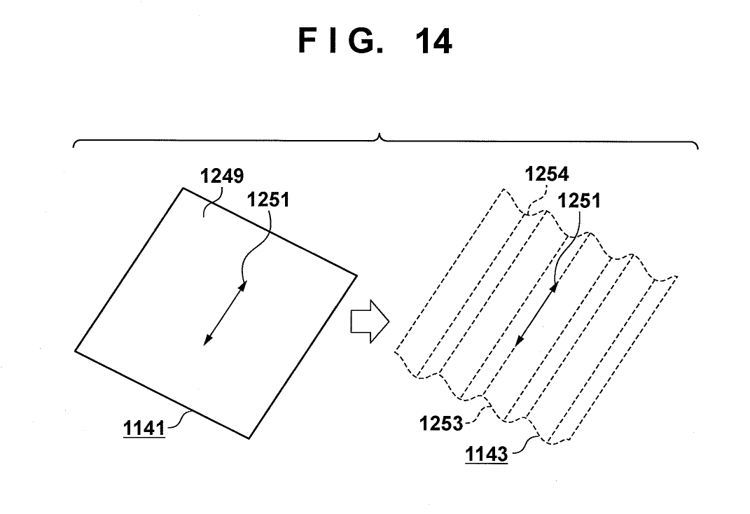

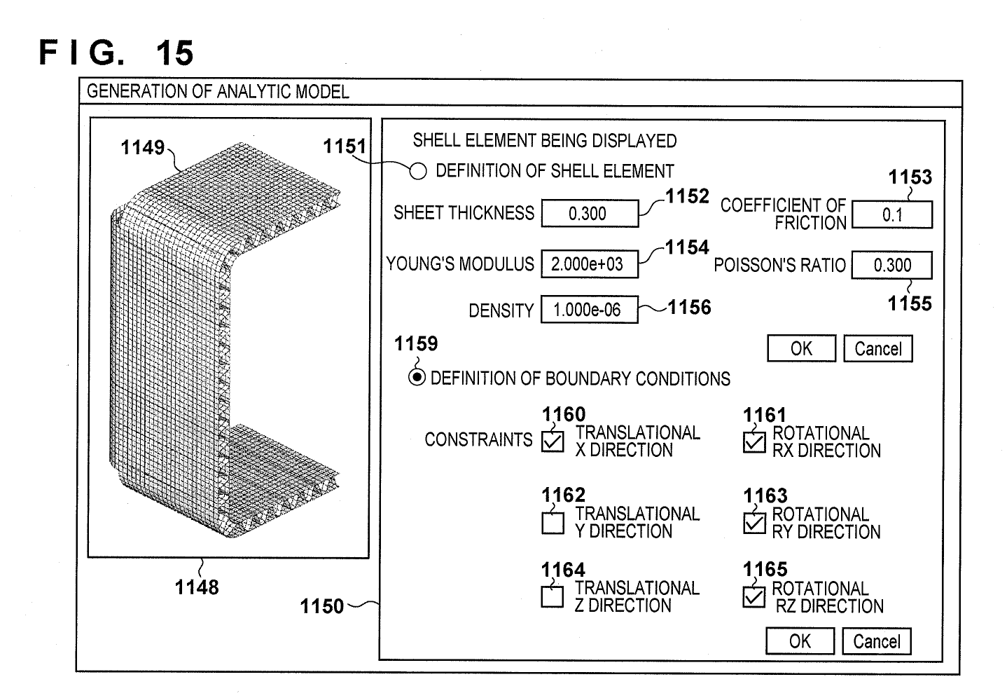

A case in which the sectional shape of the inner laminated structure of the corrugated cardboard is generated will be described with reference to FIG. 14.

A direction 1251 indicating the angle 0 of the principal axis direction is set on a mid surface 1249 of the mid surface three dimensional model 1141. Note that the direction 1251 is a direction in which the phase of the corrugation does not change, as described above. Based on the attribute information (the wave pitch 1247 and wave height 1248 of the core) of the laminated sheet, the three dimensional model generation unit 126 generates a phase shape 1253 of the sinusoidal core in a direction perpendicular to the direction 1251. The unit 126 then generates a three dimensional shape 1254 of the core using the phase shape 1253 generated with respect to the mid surface 1249. That is, the unit 126 generates the three dimensional shape 1254 of the core by extruding the phase shape 1253 in the direction 1251 by the same length as the outer length of the mid surface 1249, thereby generating the three dimensional CAD model 1143.

Note that the mid surface in generating the three dimensional CAD model 1143 is not limited to a flat surface, and may be a curved surface or the like. The phase and period of the phase shape of the sinusoidal core need not be constant.

### Creation of Analytic Model (S107)

Based on the three dimensional CAD model having an inner detailed shape generated by the three dimensional model generation unit 126, and physical property values and boundary conditions input by the user, the analytic model generation unit 127 generates an analytic model (S107).

FIG. 15 shows an example of a UI for inputting physical property values, boundary conditions, and the like. The analytic model generation unit 127 displays the UI shown in FIG. 15 on the display device 12. The UI shown in FIG. 15 has a window 1148 for displaying an analytic model 1149, and a window 1150 for defining a shell element and boundary conditions. The user can select an arbitrary number of arbitrary finite elements of the analytic model 1149 displayed in the window 1148, and define a shell element and boundary conditions.

The user can select a radio button 1151 to define the attribute information of a selected arbitrary finite element. That is, for the finite element, the user can input the sheet thickness in an input column 1152, the coefficient of friction in an input column 1153, the Young's modulus in an input column 1154, the Poisson's ratio in an input column 1155, and the density in an input column 1156.

The user can select a radio button 1159 to define the boundary conditions of a selected arbitrary region. That is, the user can select, as constraints for the region, the components of a translational direction and the components of a rotational direction using check buttons 1160 to 1165.

Note that it is possible to load the attribute information of a finite element and the boundary conditions of a region as another data file from the auxiliary storage unit 15. In this case, the input columns and check buttons in the window 1150 function as display columns for the loaded information. When the user presses an OK button, the analytic model generation unit 127 adds the attribute information defined for the finite element and the boundary conditions defined for the region to data of an analytic model stored in a main memory or the like.

Note that input for generating an analytic model is not limited to that of an element, boundary conditions, and the like. An arbitrary analytic model definition, that is, the range and contact definition of a contact region can be input.

As described above, the information processing apparatus 13 obtains two dimensional developed view data and information indicating the internal structure of a laminated sheet, and defines a three dimensional shape based on the laminated structure information of the laminated sheet. This enables to generate the three dimensional CAD model of the whole structure formed by the laminated sheet and an analytic model. Consequently, in consideration of information about a principal axis direction, a phase, and its continuous and periodic shape, which indicates the internal structure of the laminated sheet, it is possible to significantly improve the operating efficiency in generating the three dimensional CAD model of the whole structure and in generating an analytic model, thereby decreasing the number of steps of the generating operation.

### Second Embodiment

Information processing according to the second embodiment of the present invention will be described below. In the second embodiment, creation of a three dimensional model and an analytic model in consideration of a case in which a sheet-shaped component like a laminated sheet has a sheet thickness changed portion will be explained. In the second embodiment, the same components as in the first embodiment have the same reference numerals and a description thereof will be omitted.

### [Arrangement of Apparatus]

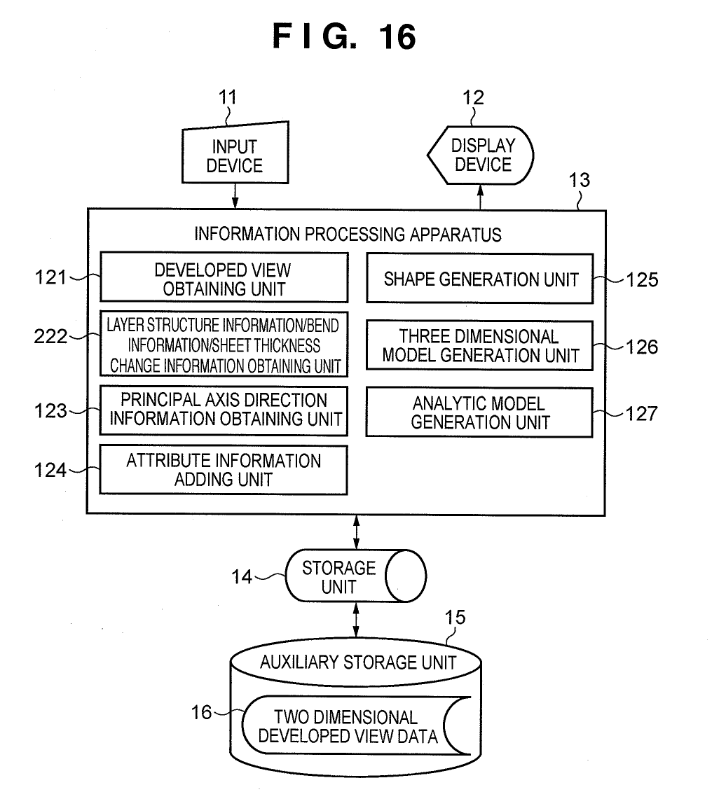

The arrangement of an information processing apparatus 13 according to the second embodiment will be described with reference to a block diagram shown in FIG. 16.

Like the layer structure information/bend information obtaining unit 122 in the first embodiment, a layer structure information/bend information/sheet thickness change information obtaining unit 222 obtains the layer structure information and bend information of a laminated sheet. The unit 222 also obtains the sheet thickness change information of a sheet thickness changed portion provided by processing, in advance, a position of the laminated sheet corresponding to a bending part. Note that setting of a sheet thickness changed portion is often used in a cardboard structure or the like to facilitate creation of a bending part.

A principal axis direction information obtaining unit 123 obtains the principal axis direction information of the laminated sheet, as in the first embodiment. An attribute information adding unit 124 defines, for all surfaces, the sheet thickness change information of the laminated sheet in addition to the layer structure information and bend information of the laminated sheet and the principal axis direction information of the laminated sheet.

Based on the sheet thickness change information of the laminated sheet in addition to the shape and dimensions of a three dimensional structure, and the structure information, bend information, and principal axis direction information of the laminated sheet, a shape creating unit 125 creates the three dimensional shape of the structure as a whole when the laminated sheet is bent by considering a mid surface as a reference surface.

For the sheet-shaped three dimensional shape created by the shape creating unit 125, a three dimensional model creating unit 126 creates a three dimensional CAD model as a detailed three dimensional shape having a continuous and periodic inner laminated structure across neighboring surfaces. At this time, the developed length is corrected, and details thereof will be described later.

An analytic model creating unit 127 creates an analytic model based on the three dimensional CAD model defined by the three dimensional model creating unit 126, as in the first embodiment.

### [Creation Processing of Three Dimensional CAD Model and Analytic Model]

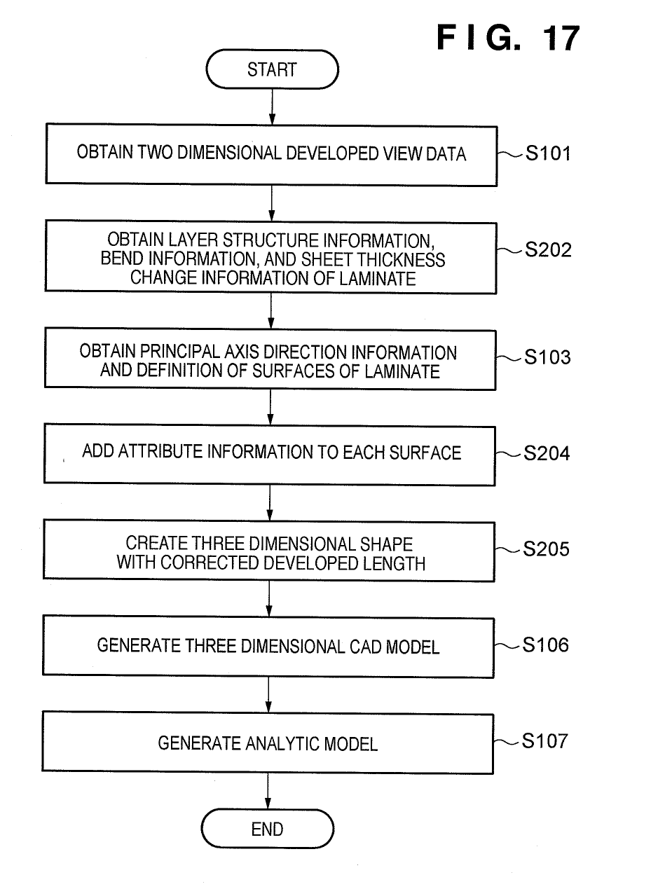

Processing of generating a three dimensional CAD model and an analytic model based on two dimensional developed view data will be described with reference to a flowchart shown in FIG. 17. A detailed description of processing of obtaining two dimensional developed view data (S101), processing of obtaining principal axis direction information (S103), creation of a three dimensional CAD model (S106), and creation of an analytic model (S107), all of which are the same as those in the first embodiment, will be omitted.

Obtaining of Layer Structure Information, Bend information, and Sheet Thickness Change Information (S202)

The layer structure information/bend information/sheet thickness change information obtaining unit 222 obtains the layer structure information, bend information, and sheet thickness change information of a laminated sheet using a UI (S202). That is, the layer structure information/bend information/sheet thickness change information obtaining unit 222 obtains various kinds of attribute information held by a corrugated cardboard shown in FIG. 4.

A UI exemplified in FIG. 5 is used to input the layer structure information and a UI exemplified in FIG. 6 is used to input the bend information but a detailed description thereof will be omitted.

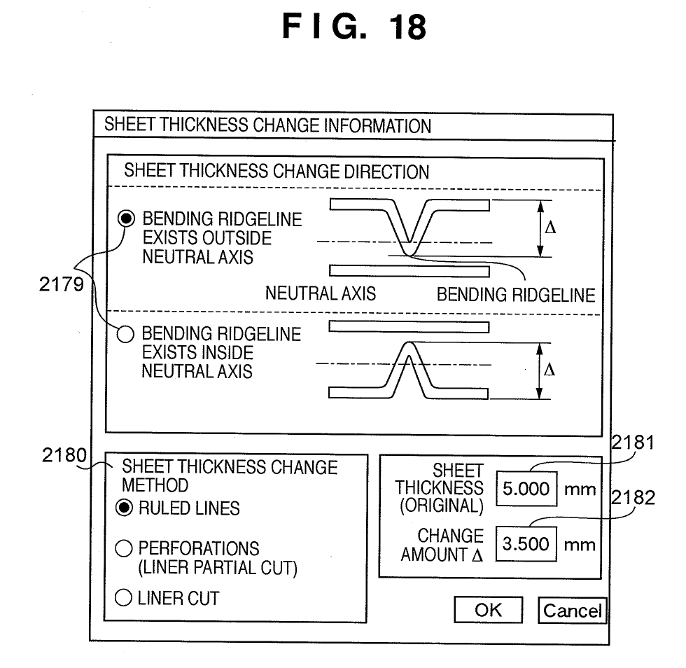

FIG. 18 shows an example of a UI for inputting the sheet thickness change information. The layer structure information/bend information/sheet thickness change information obtaining unit 222 displays the UI shown in FIG. 18 on a display device 12. The user inputs the sheet thickness change information of the laminated sheet using an input device 11 and the UI shown in FIG. 18.

The user selects a sheet thickness change direction using a radio button 2179. That is, the user selects, as a sheet thickness change direction, whether the ridgeline of a bending part exists outside or inside the neutral axis of the sheet thickness. Furthermore, the user uses a radio button in a sheet thickness change method column 2180 to select whether a sheet thickness change is implemented by ruled lines, perforations (a liner partial cut), or a liner cut. The user also inputs the sheet thickness (original) of the laminated sheet before sheet thickness change in an input column 2181, and inputs a change amount A of the sheet thickness of the sheet thickness changed portion in an input column 2182.

When the user selects the radio buttons in the columns of the UI shown in FIG. 18, inputs numerical values, and then presses an OK button, an operation of obtaining the layer structure information, bend information, and sheet thickness change information by the layer structure information/bend information/sheet thickness change information obtaining unit 222 ends.

Note that a method of inputting the layer structure information, bend information, and sheet thickness change information using the UI by the user has been described above. If, however, the two dimensional developed view data contains layer structure information, bend information, and sheet thickness change information, the layer structure information/bend information/sheet thickness change information obtaining unit 222 can obtain the layer structure information, bend information, and sheet thickness change information from the two dimensional developed view data.

### Adding of Attribute Information (S204)

The attribute information adding unit 124 adds, as attribute information, layer structure information, bend information, sheet thickness change information, principal axis direction information, and the definition of surfaces to all surfaces (S204).

Creation of Three Dimensional Shape with Corrected Developed Length (S205)

Based on a shape and dimensions indicated by the two dimensional developed view data, and the bend information of the laminated sheet, the shape creating unit 125 creates a sheet-shaped three dimensional shape formed by planar portions and a bending part by considering a mid surface as a reference surface. Note that the reference surface is not limited to the mid surface, and may be an outer surface or inner surface. Along with addition of a unit vector V representing the principal axis direction of the laminated sheet to the two dimensional developed view data, the shape creating unit 125 also adds a unit vector V′ representing a direction parallel to the bending ridgeline of the bending part to the two dimensional developed view data.

As shown in FIG. 10, the three dimensional shape is basically represented as a mid surface three dimensional model 1141 formed by planar portions 1139 and a bending part 1140.

To create the three dimensional shape, in general, outer shape dimensions are determined by defining the position of the mid surface of the two dimensional developed view as a bending position, and adding half the sheet thickness to each bending part. Considering the sheet thickness changed portion, however, the outer shape dimensions are not always determined in such a manner. In consideration of the principal axis direction of the inner laminated structure in addition to the sheet thickness changed portion, a sheet thickness change amount changes depending on an angle formed between the direction of a bending ridgeline portion and the principal axis direction of the inner laminated structure. That is, even if the mid surface position of the two dimensional developed view is considered as a bending position and half the sheet thickness is added to each bending part, the outer shape dimensions are not determined.

In this embodiment, to create a three dimensional shape, a bending position obtained based on the position of the mid surface of the two dimensional developed view is corrected by adding/subtracting a correction amount ranging from a positive value to a negative value according to the number of times of bending, thereby obtaining a correct three dimensional shape. That is, in consideration of the layer structure information, bend information, sheet thickness change information, principal axis direction information, and the definition of surfaces, a three dimensional shape with a corrected developed length is created (S205).

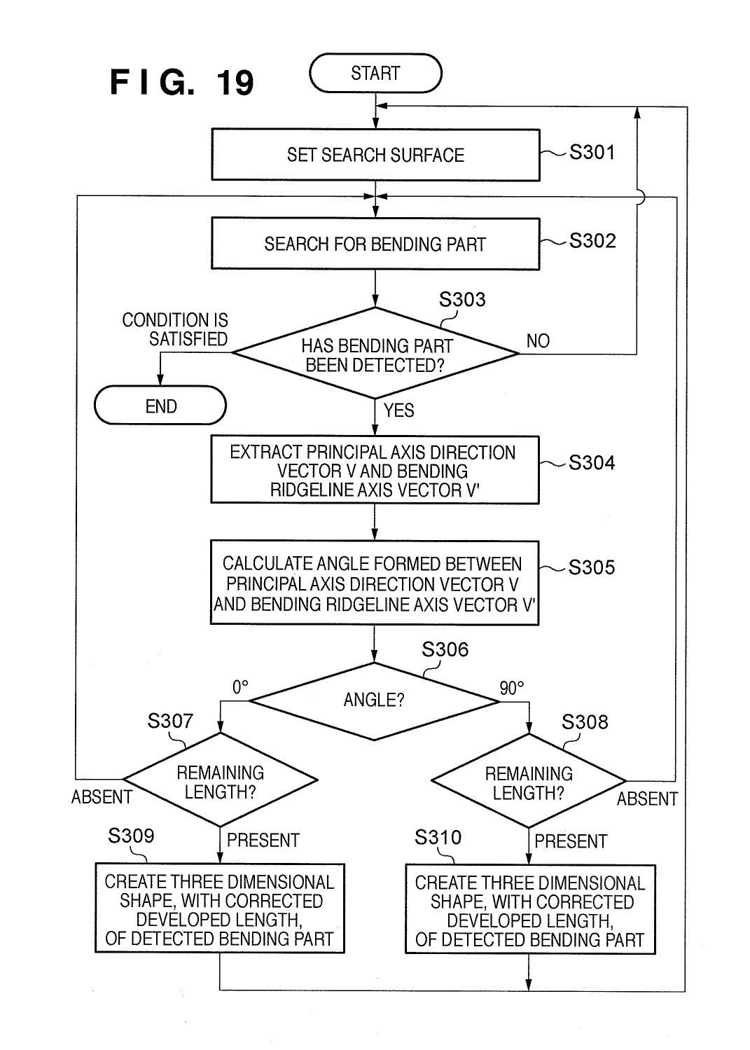

Processing (S205) of creating a three dimensional shape with a corrected developed length will be described in detail with reference to a flowchart shown in FIG. 19.

A reference planar portion is set as a bend search surface (S301). A bending part is searched for on the search surface (S302). Whether a bending part has been detected is determined (S303). If a bending part has been detected, a principal axis direction vector V on the search surface and a bending ridgeline axis vector V′ of the bending part are extracted (S304). An angle formed between the vectors is calculated (S305).

The process branches depending on whether the angle formed between the vectors is 90° or 0° (S306). Whether a remaining length is present is determined (S307 and S308). If the remaining length is present, the three dimensional shape, with a corrected developed length, of the bending part is created (S309 and S310). At this time, attribute information such as layer structure information, bend information, sheet thickness change information, and principal axis direction information stored in a storage unit 14 are referred to.

If the three dimensional shape of the detected bending part has been created, the process returns to step S301 to set, as a search surface, a new flat surface created by the bending part (S301). A bending part is searched for on the new search surface.

If it is determined that the remaining length is absent, the process returns to step S302 to search for a bending part on the search surface.

If no bending part is detected on the search surface (S303), the process returns to step S301 to set, again, a preceding flat surface as a search surface (S301). The processing in steps S302 to S309 is repeated. If setting the reference planar portion again as a search surface, detects no new bending part (S303), in other words, if the condition for completion is satisfied, the creation processing (S205) of the three dimensional shape with a corrected developed length ends.

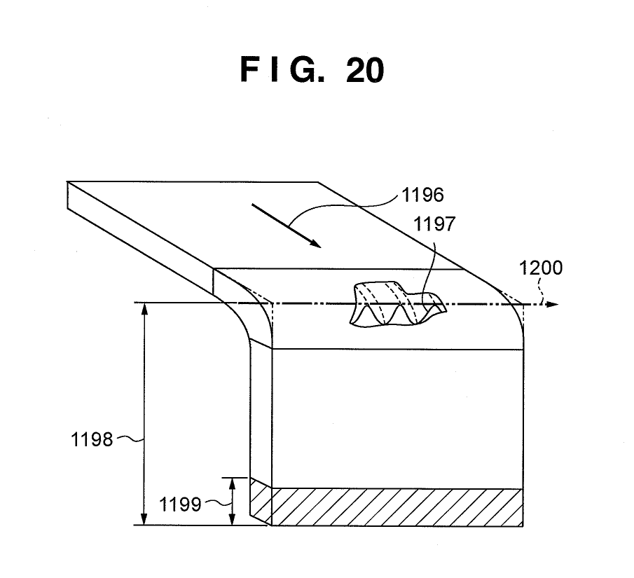

FIG. 20 shows an example of a three dimensional shape creation result with a corrected developed length. An angle formed between a principal axis direction vector 1196 of the laminated sheet determined based on a core shape 1197 and a vector 1200 parallel to a bending ridgeline is calculated by the inner product. After the remaining length is calculated based on a developed length nominal dimension 1198 of a bend interval determined based on the outer shape dimensions, a correction amount 1199 is added/subtracted. In consideration of the layer structure information, bend information, sheet thickness change information, and principal axis direction information stored in the storage unit 14, the correction amount 1199 is calculated, for each bending part, as a correction amount ranging from a positive value to a negative value, and is then reflected to the three dimensional shape dimensions.

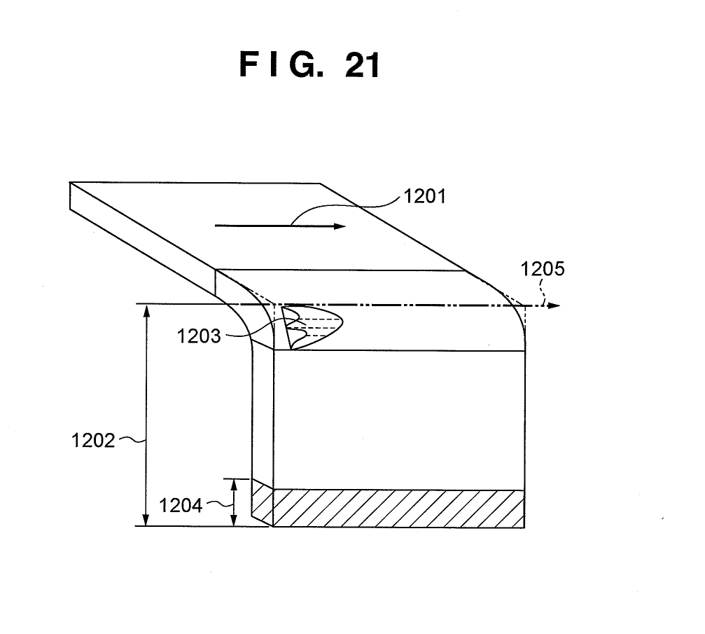

FIG. 21 shows another example of a three dimensional shape creation result with a corrected developed length. An angle formed between a principal axis direction vector 1201 of the laminated sheet determined based on a core shape 1203 and a vector 1205 parallel to a bending ridgeline is calculated by the inner product. After the remaining length is calculated based on a developed length nominal dimension 1202 of a bend interval determined based on the outer shape dimensions, a correction amount 1204 is added/subtracted. In consideration of the layer structure information, bend information, sheet thickness change information, and principal axis direction information stored in the storage unit 14, the correction amount 1204 is calculated, for each bending part, as a correction amount ranging from a positive value to a negative value, and is then reflected to the three dimensional shape dimensions.

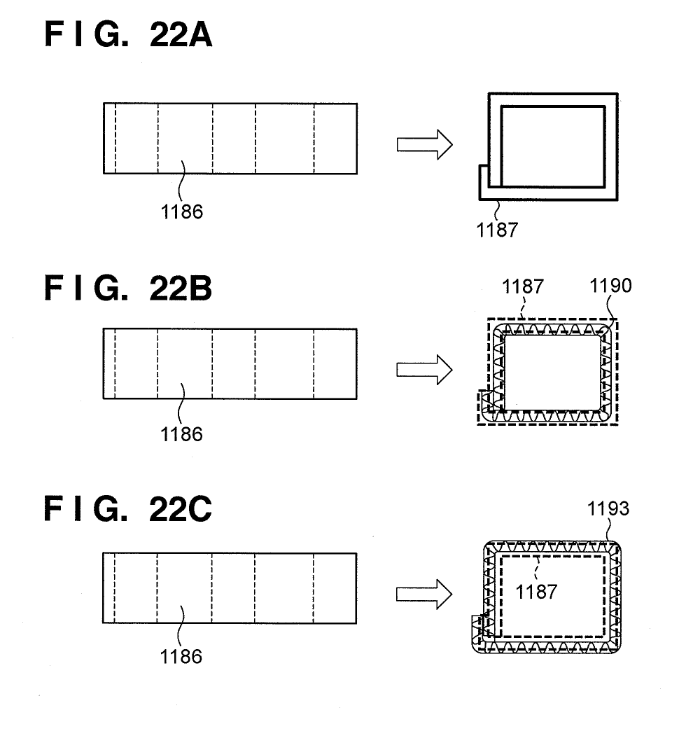

FIGS. 22A to 22C are views each showing an example of a three dimensional outer shape created based on two dimensional developed view data. FIG. 22A shows a case in which a mid surface is considered as a bending position of the two dimensional developed view and the sheet thickness is made uniform, thereby creating a three dimensional shape 1187 based on two dimensional developed view data 1186.

FIG. 22B shows a case in which a three dimensional shape 1190 is created based on the two dimensional developed view data 1186 in consideration of the layer structure information, bend information, sheet thickness change information, principal axis direction information, and the definition of surfaces. As shown in FIG. 22B, the three dimensional shape 1190 is created smaller than the three dimensional shape 1187. This example applies to a case in which the bending ridgeline exists outside the neutral axis, as is apparent from the UI shown in FIG. 18 provided by the layer structure information/bend information/sheet thickness change information obtaining unit 222.

FIG. 22C shows a case in which a three dimensional shape 1193 is created based on the two dimensional developed view data 1186 in consideration of the layer structure information, bend information, sheet thickness change information, principal axis direction information, and the definition of surfaces. As shown in FIG. 22C, the three dimensional shape 1193 is created larger than the three dimensional shape 1187. Note that this example applies to a case in which the bending ridgeline exists inside the neutral axis, as is apparent from the UI shown in FIG. 18.

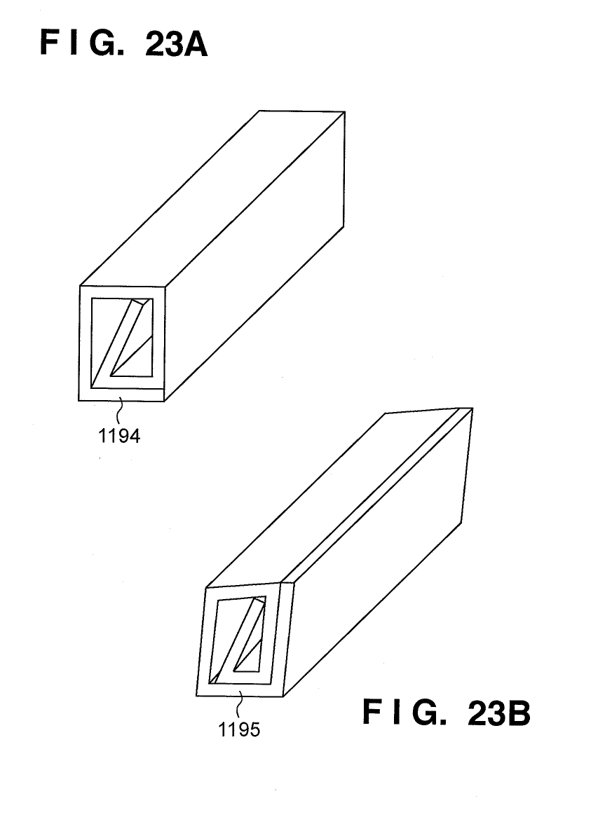

FIGS. 23A and 23B are views each showing an example of the three dimensional shape created based on the two dimensional developed view. FIG. 23A shows an example of a three dimensional shape 1194 with a uniform sheet thickness created by considering a mid surface as a bending position of the two dimensional developed view without consideration of the laminated structure. FIG. 23B shows an example of a three dimensional shape 1195 created based on the two dimensional developed view in consideration of the layer structure information, bend information, sheet thickness change information, and principal axis direction information. The three dimensional shape 1195 is created smaller than the three dimensional shape 1194, and reproduces the inclination, with a small angle, of each surface of an actual product.

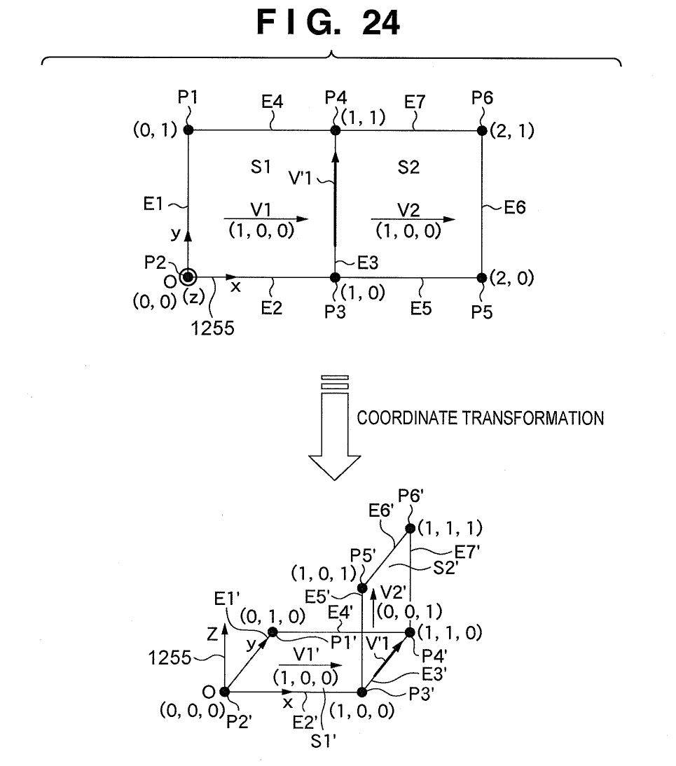

FIG. 24 shows a case in which three dimensional shape data is created based on two dimensional developed view data. Note that the two dimensional developed view data shown in FIG. 24 shows two surfaces like FIG. 3A for descriptive convenience. An actual structure, however, has more surfaces, as a matter of course.

Based on the two dimensional information of the two dimensional developed view data, and the layer structure information, bend information, sheet thickness change information, principal axis direction information, definition of surfaces and reference surface (for example, mid surface) of the laminated sheet, the shape creating unit 125 sets a three dimensional coordinate system 1255, and generates three dimensional information (a three dimensional shape).

To generate three dimensional information, a rotating coordinate transformation about a bending line (ridgeline) and the like need only be performed. For example, points P1 to P6 shown in FIG. 24 are coordinate-transformed to generate points P1′ to P6′, which coordinate-transforms edges E1 to E7 to edges El' to E7′, and surfaces S1 and S2 to surfaces S1′ and S2′. In the example shown in FIG. 24, especially the positions of the points P5 and P6 and the edges E5 to E7 move in the positive Z axis direction (+Z direction).

As shown in FIG. 24, the shape creating unit 125 adds, to the two dimensional developed view data, unit vectors V1 and V2 each representing the principal axis direction of the laminated sheet. Along with the coordinate transformation of points P in generation of three dimensional information, the unit vectors V1 and V2 are coordinate-transformed to unit vectors V1′ and V2′, respectively.

Similarly, as shown in FIG. 24, the shape creating unit 125 adds, to the two dimensional developed view data, a unit vector V′l representing a direction parallel to the bending ridgeline of the bending part. Along with the coordinate transformation of the points P in generation of three dimensional information, the unit vector V′1 is coordinate-transformed to a unit vector V′1′.

In other words, it is possible to generate three dimensional information indicating the principal axis direction of each surface. According to a conventional method, it is necessary to set a principal axis direction for each surface after generating three dimensional information based on the two dimensional developed view data. According to this embodiment, the principal axis direction of each surface is generated when generating three dimensional information, which eliminates the need for setting a principal axis direction after creating the three dimensional information.

Furthermore, it is also possible to generate three dimensional information indicating a direction parallel to the bending ridgeline of each bending part. According to a conventional method, it is necessary to set a direction parallel to the bending ridgeline of each bending part after generating three dimensional information based on the two dimensional developed view data. According to this embodiment, a direction parallel to the bending ridgeline of each bending part is generated when generating three dimensional information, which eliminates the need for setting a direction parallel to the bending ridgeline after creating the three dimensional information.

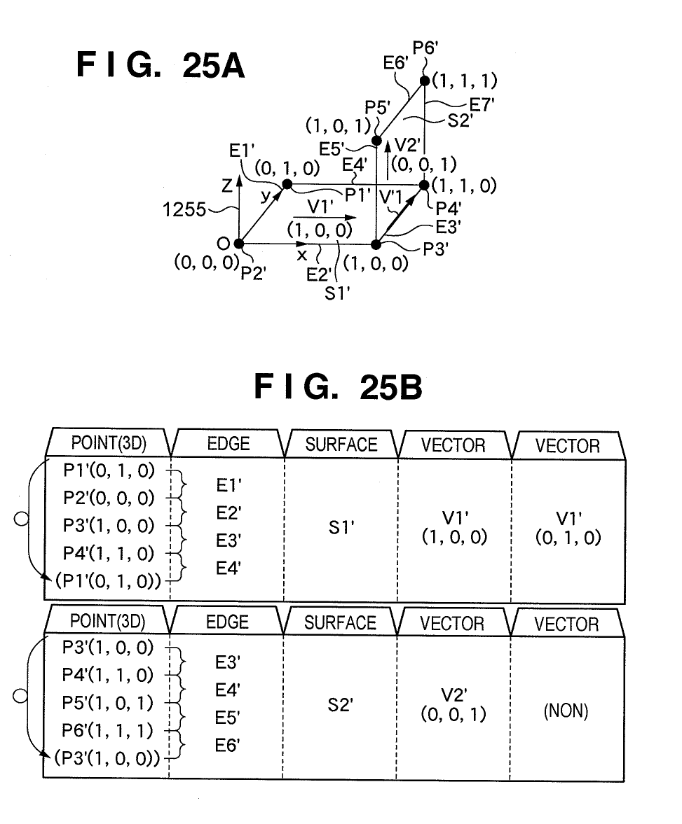

FIGS. 25A and 25B show an example of the data structure of the three dimensional shape data. The three dimensional shape data shown in FIG. 25A has a data structure example shown in FIG. 25B. That is, the three dimensional shape data has a hierarchical structure which includes data of edges E forming each surface S and data of points P forming each edge E, and data of vectors V each indicating a principal axis direction and vector V′ indicating a direction parallel to the bending ridgeline. Note that FIGS. 25A and 25B only show information for two surfaces and one ridgeline but information for the number of surfaces and that of ridgelines in the developed view actually exist.

As described above, the three dimensional information generation procedure by the shape creating unit 125, that is, a procedure of creating a three dimensional shape based on the two dimensional developed view data can use a conventional method such as coordinate transformation. By adding, to the two dimensional development view data, the unit vectors V each representing a principal axis direction and the unit vector V′ representing a direction parallel to the bending ridgeline, it is possible to generate unit vectors representing a direction parallel to the bending ridgeline and the principal axis direction of each surface in the three dimensional shape.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2011-017117, filed Jan. 28, 2011 and 2011-289898, filed Dec. 28, 2011, which are hereby incorporated by reference herein in their entirety.

What is claimed is:

1. An information processing apparatus comprising:
an obtaining section, configured to obtain two dimensional developed view data of a three dimensional structure;
an inputting section, configured to input layer structure information of a sheet-shaped component which has a laminated structure and includes an inner structure having a corrugated form, and bend information of a bending part indicated by the two dimensional developed view data;
a setting section, configured to set, for coordinates of the two dimensional developed view data, a principal axis direction indicating a direction in which a shape of the inner structure does not change;
an adding section, configured to add the layer structure information and information representing the principal axis direction to each surface indicated by the two dimensional developed view data;
a first generator, configured to generate a three dimensional shape of the three dimensional structure using the two dimensional developed view data and the bend information; and
a second generator, configured to generate, using the layer structure information and the information representing the principal axis direction which have been added to each surface, a three dimensional model in which a shape of the laminated structure of the sheet-shaped component is added to each surface indicated by the three dimensional shape,
wherein the first and second determiners are implemented using a processor.

2. The apparatus according to claim 1, further comprising a third generator configured to generate an analytic model from the three dimensional model.

3. The apparatus according to claim 1, wherein the adding section adds, as the information representing the principal axis direction, a unit vector indicating the principal axis direction to each surface.

4. The apparatus according to claim 1, wherein the first generator generates the three dimensional shape by coordinate-transforming point data of the two dimensional developed view data corresponding to vertices of surfaces of the three dimensional structure.

5. The apparatus according to claim 1, further comprising a defining section configured to define a relationship between each surface indicated by the two dimensional developed view data and a surface of the sheet-shaped component.

6. The apparatus according to claim 1, wherein the bend information contains information indicating a change in sheet thickness of a sheet thickness changed portion provided, in advance, at a position of the sheet-shaped component corresponding to the bending part.

7. The apparatus according to claim 1, wherein the first generator for the three dimensional shape creates dimensions of the bending part with respect to a mid surface obtained from the two dimensional developed view data, and corrects the dimensions of the bending part with a correction amount based on the layer structure information, the information representing the principal axis direction, and the bend information.

8. An information processing method comprising:
using a processor to perform the steps of:
obtaining two dimensional developed view data of a three dimensional structure;
inputting layer structure information of a sheet-shaped component which has a laminated structure and includes an inner structure having a corrugated form, and bend information of a bending part indicated by the two dimensional developed view data;
setting, for coordinates of the two dimensional developed view data, a principal axis direction indicating a direction in which a shape of the inner structure does not change;
adding the layer structure information and information representing the principal axis direction to each surface indicated by the two dimensional developed view data;
generating a three dimensional shape of the three dimensional structure using the two dimensional developed view data and the bend information; and
generating, using the layer structure information and the information representing the principal axis direction which have been added to each surface, a three dimensional model in which a shape of the laminated structure of the sheet-shaped component is added to each surface indicated by the three dimensional shape.

9. A non-transitory computer readable medium storing a computer executable-program for causing a computer to perform an information processing method, the method comprising the steps of:
obtaining two dimensional developed view data of a three dimensional structure;
inputting layer structure information of a sheet-shaped component which has a laminated structure and includes an inner structure having a corrugated form, and bend information of a bending part indicated by the two dimensional developed view data;
setting, for coordinates of the two dimensional developed view data, a principal axis direction indicating a direction in which a shape of the inner structure does not change;
adding the layer structure information and information representing the principal axis direction to each surface indicated by the two dimensional developed view data;
generating a three dimensional shape of the three dimensional structure using the two dimensional developed view data and the bend information; and
generating, using the layer structure information and the information representing the principal axis direction which have been added to each surface, a three dimensional model in which a shape of the laminated structure of the sheet-shaped component is added to each surface indicated by the three dimensional shape.
